(19) United States
(12) Patent Application Publication
(10) Pub. No.: US 2009/0283046 A1
(43) Pub. Date: Nov. 19, 2009

(54) BIRD FEEDING PORT ASSEMBLY

(75) Inventor: Derek James Black, York (GB)

Correspondence Address: BROOKS KUSHMAN P.C., 1000 TOWN CENTER, TWENTY-SECOND FLOOR, SOUTHFIELD, MI, 48075, US

(73) Assignee: CRANSWICK PET AND AQUATICS PLC, Kingston Upon Hull (GB)

(21) Appl. No.: 12/122,049

(22) Filed: May 16, 2008

(51) Int. Cl. A01K 39/012

(52) U.S. Cl. 119/52.3; 119/52.1; 119/52.2

(57) ABSTRACT

A bird feeding port assembly (1) for mounting to a bird feed containment housing (2) through an opening in the wall of the housing (2), the assembly (1) defining a feeding area (4) having an opening to the housing (2), a support frame (3) which is adapted in use to secure the assembly (1) to the housing (2) such that the opening to the housing allows seed to flow into the feed area (4), and a closure member (9) which is moveable between a first extended position in which the closure member (9) extends outwardly from the outward side of the assembly (1) leaving the feeding area (4) open and a second retracted position in which the closure member (9) overlies the feeding area (4) and prevents access thereto.

The feeding area (4) may comprise a bowl (4) that can project outwardly from, or be located within, the containment housing (2). The closure member (9) can pivot or slide between the first and second positions.

### BACKGROUND OF THE INVENTION

1. Field of the Invention

The present invention relates to bird feeders. More specifically, the present invention relates to a bird feeding port assembly for mounting to a bird feed containment housing through feed openings in the wall of the housing.

2. Background Art

Commercially available bird feeders come in a great variety of designs and configurations. One such bird feeder comprises a vertically orientated housing for retaining the bird feed with one or more openings in the wall of the housing to facilitate access to bird feed within the housing. A bird feeding port assembly is mounted in each opening, and generally comprises a locating member which serves to locate the assembly in the opening and which defines a port into the interior of the housing, a perch which extends outwardly from the assembly at the bottom of the port, and a deflector which extends rearwardly of the locating member into the housing exterior to cover or shield the port opening to prevent gravitational discharge of bird feed through the opening, whilst still permitting birds to access bird feed retained within the housing by reaching into the port.

Bird feeders tend to be packaged for sale in a fully assembled state and where the perch protrudes directly from the housing this requires the use of a packing box considerably larger in cross-section than the housing. This incurs additional costs and is wasteful of resources. UK Patent No. 2398719 avoids this problem by providing a bird feeding port assembly in which the perch is provided with pivoting means. The pivoting means allow the perch to pivot relative to the locating member from a retracted position in which the perch is folded back along the side of the housing to an extended position in which the perch projects outwardly from the housing such that a bird may rest upon it to feed through the port.

Conventional bird feeding port assemblies, such as that disclosed in UK Patent No. 2398719, are not suitable for use with bird feeders which are pre-filled with bird feed. There is no mechanism for closing the port in the assembly and as a result bird feed leaks out during movement of the bird feeder. This may occur when the bird feeder is transported from the supplier to retail outlets or when the bird feeder is moved by the end user.

### SUMMARY OF THE INVENTION

It is an object of the present invention to provide a bird feeding port assembly which provides a perch which can be stowed away for storage and for transportation.

It is another object of the present invention to provide a bird feeding port assembly which can be closed to prevent bird feed escaping from the bird feeder. According to the present invention there is provided a bird feeding port assembly for mounting to a bird feed containment housing through an opening in the wall of the housing, the assembly defining a feeding area having an opening to the housing, a support frame which is adapted in use to secure the assembly to the housing such that the opening to the housing allows seed to follow into the feed area, and a closure member which is moveably between a first extended position in which the closure member extends outwardly from the outward side of the assembly leaving the feeding area open and a second retracted position in which the closure member overlies the feeding bowl and prevents access thereto.

When the assembly according to the present invention is mounted to a bird feed containment housing bird feed passes from the housing through the opening in the wall thereof and into the feeding area. When the bird feeder is being transported the closure member is closed to overlie the feeding area and thereby prevent bird feed from leaking out. When the bird feeder is positioned for use the closure member is pulled out into the extended position, thereby opening the feeding area and allowing birds access to the bird feed contained therein. In the extended position the closure member serves as a perch on which birds can stand to feed from the feeding area.

In a preferred embodiment of the present invention the feeding bowl comprises a feeding bowl having an opening in the rear thereof and the support means is adapted to secure the feeding bowl to the exterior of the housing such that the opening in the rear of the feeding bowl is aligned with the opening in the housing wall. The assembly further comprises a cover or hood located above and spaced from the feeding bowl. The space between the cover and the feeding bowl is sufficient to allow birds access to the interior of the feeding bowl, whilst preventing rain from falling into the bowl and spoiling the bird feed held therein. The feeding bowl and the cover may be formed together as a single unitary construction, by, for example, moulding them in plastics material.

In a preferred embodiment of the present invention the closure member takes the form of planar member and is slidable within slots and/or grooves in the feeding bowl between the first extended position and the second retracted position. The planar closure member may be retained by and slidable within a slot in the outward side of the feeding bowl. Alternatively, or in addition, the sides of the planar closures member may be retained by and slidable within a pair of grooves on opposite sides of the feeding bowl.

Preferably the closure member comprises a stop bar on the rearward edge thereof which prevents it from being slide out of the slots and/or grooves in the feeding bowl which retain it. In one embodiment the stop bar abuts against the inner face of the outward side of the feeding bowl. In another embodiment of the present invention the closure member extends through the opening in the rear of the feeding bowl and into the housing, and the stop bar engages against the uppermost side of the opening. In this embodiment the rearward edge of the closure member is shaped so as to substantially match the shape of the feeding bowl. This ensures that when the closure member is in the first extended position the rearward edge of the closure member lies over or past the feeding bowl, thereby facilitating full access to the contents of the feeding bowl.

In another embodiment of the present invention the closure member is connected to the outward side of the feeding bowl by a hinge and is pivotable between the first extended position and the second retracted position.

Preferably, the support frame forms a snap fit within the opening in the wall of the bird feed containment housing.

### BRIEF DESCRIPTION OF THE DRAWINGS

An embodiment of the present invention will now be described, by way of example, with reference to the accompanying drawings, in which:

FIG. 1 shows a perspective view of a feeding port assembly according to the present invention in the fully closed position;

FIG. 2 shows a perspective view of the feeding port assembly shown in FIG. 1 in the fully open position;

FIG. 3 shows a partial sectioned side view of a tubular bird feeder having the feeding port assembly shown in FIG. 1 attached thereto in the fully closed position;

FIG. 4 shows a partial sectioned side view of a tubular bird feeder having the feeding port assembly shown in FIG. 1 attached thereto in the fully open position;

FIG. 5 shows a sectioned top view of a tubular bird feeder having the feeding port assembly shown in FIG. 1 attached thereto in the fully closed position; and

FIG. 6 shows a sectioned top view of a tubular bird feeder having the feeding port assembly shown in FIG. 1 attached thereto in the fully closed position.

### DETAILED DESCRIPTION OF THE PREFERRED EMBODIMENT(S)

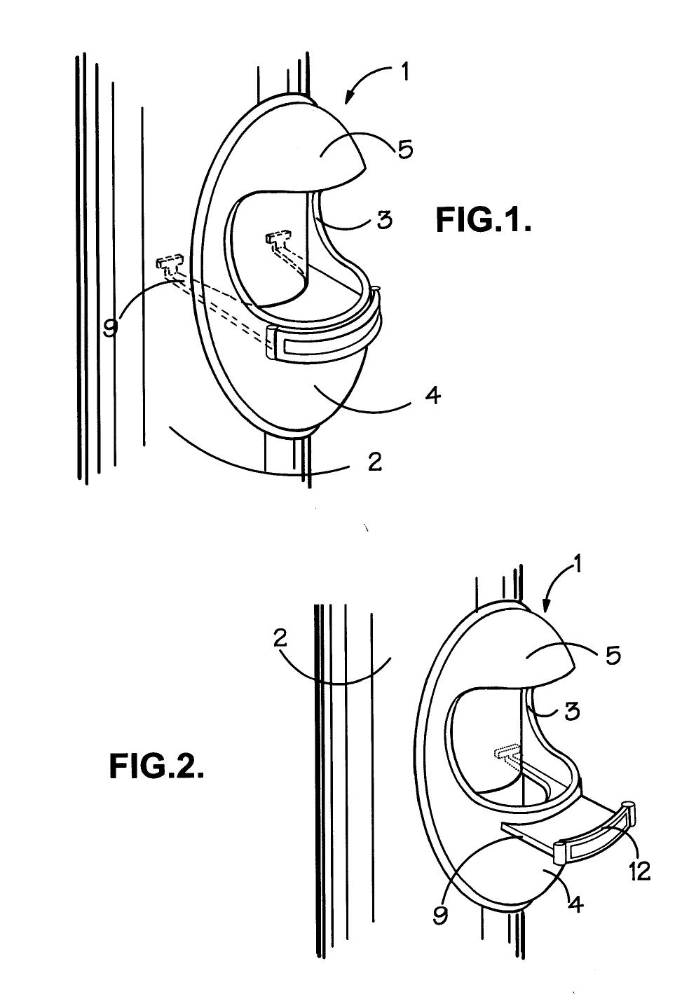

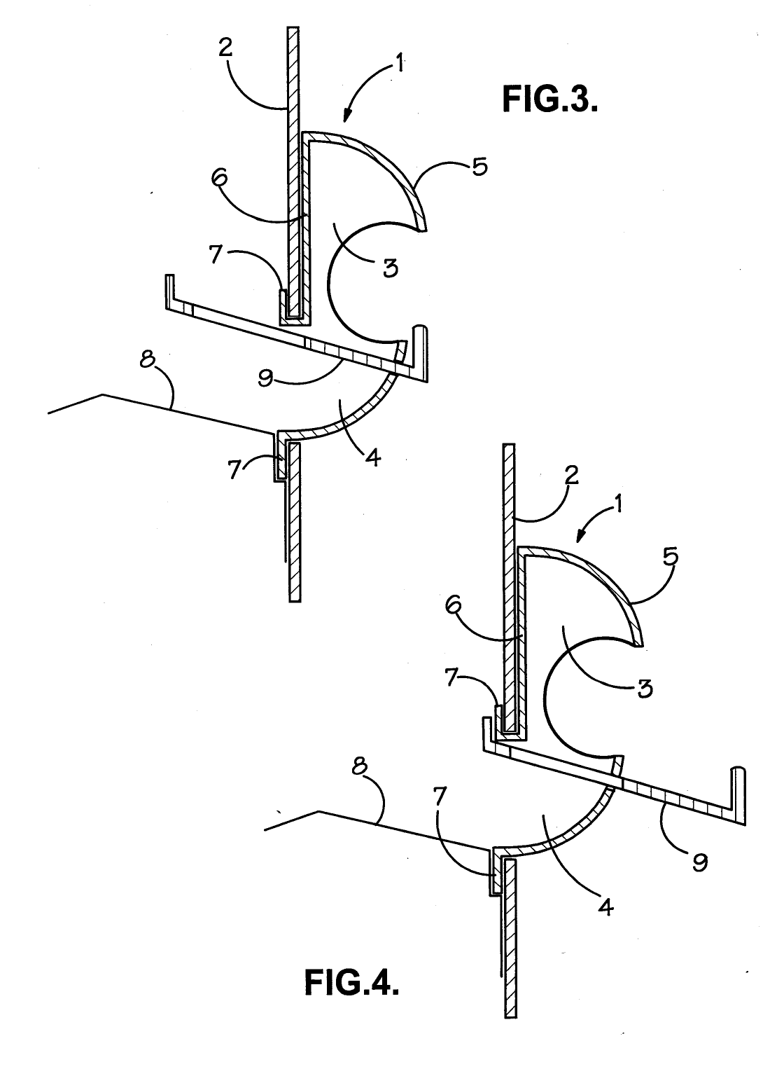

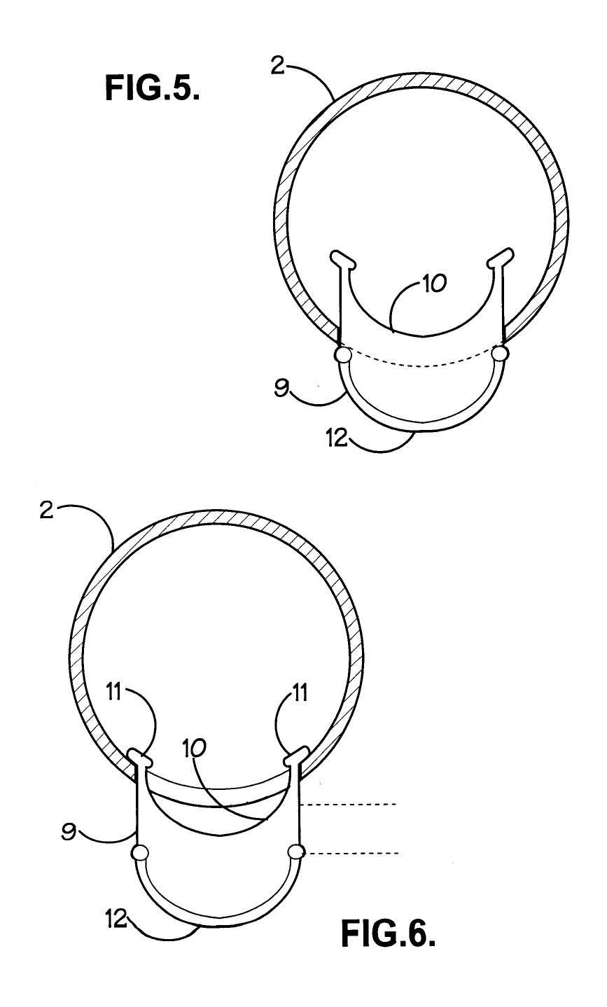

Referring to the accompanying drawings there is shown a bird feeding port assembly according to the present invention, generally designated by the reference 1, which is mounted to a bird feed containment housing 2 through an opening (not visible) in the wall thereof. In FIGS. 1, 3 and 5 the assembly 1 is shown in a fully closed position. In FIGS. 2, 4 and 6 the assembly 1 is shown in a fully open position. The assembly 1 comprises a first part 3 which defines a feeding bowl 4 and a cover 5 for the feeding bowl 4. The cover 5 is spaced from the feeding bowl 4 to defining an opening through which a bird may access bird feed contained within the feeding bowl 4, whilst still shielding the feeding bowl against rainfall which might otherwise spoil the bird feed. Referring to FIG. 3 of the drawings it can be seen that the first part 3 further comprises a back wall 6 which is so shaped as to sit flush to the outer wall of the housing 2 and which defines an aperture immediately behind the feeding bowl 4. The sides of the aperture terminate in snap-fit projections 7 which are adapted to securely mount the assembly in the opening in the wall of the housing 2. It will be apparent that with the assembly 1 mounted to the bird feed containment housing 2, bird feed contained within the housing 2 is able to pass freely from the housing 2 into the feeding bowl 4 where it will be accessible to birds. As shown in FIG. 3 the base 8 of the housing 2 is shaped so as to direct bird feed through the opening in the housing wall and into the feeding bowl. However, bird feed will tend to spill out into the feeding bowl 4 under its own weight when the bird feeder is full to a point above the top of the opening.

The assembly also comprises a second part 9 which forms a closure member. The closure member 9 is mounted in a slot in the outward side of the feeding bowl 4 and is slidable within the slot between the fully retracted position and the fully extended position.

In the fully retracted position, the closure member 9 overlies the feeding bowl 4 and prevents access to any bird feed contained therein. It also serves to prevent bird feed from spilling out of the feeding bowl 4 if the bird feeder is turned upside down or shaken, as it would be during transit from the supplier to retail outlets. This allows the bird feeder to be shipped from the supplier pre-filled with bird feed without risk that some or all of the contents of the bird feeder will be lost in transit. In the fully extended position, the closure member 9 is pulled outwardly from outward side of the feeding bowl 4 to expose the contents of the feeding bowl 4. In order to facilitate access to the contents of the feeding bowl 4 past the closure member 9 the rearward edge 10 of the closure member 9 is shaped so as to substantially match the shape of the feeding bowl. This is best seen in FIG. 6. A stop bar 11 is provided on each side of the rearward edge 10 of the closure member 9 and these abut against the top of the aperture in the back wall 6 to prevent the closure member 9 from being inadvertently pulled from the slot in the feeding bowl 4. The outward edge 12 of the closure member 9 is turned upwardly to form a perch on which a bird can stand to reach for bird feed contained within the feeding bowl 4.

The bird feeding port assembly according to the present invention uniquely combines a perch for a feeding bird to stand upon to access bird food and a closure member which allows the feed openings in a bird feeder to be closed and sealed, thereby allowing the bird feeder to be shipped pre-filled with bird feed without risk that it will escape or become contaminated. Although the present invention has been described with reference to a closure member which is slidably mounted to the feeding bowl, this is not essential. By way of an alternative the closure member may be pivotable about the forward edge of the feeding bowl between on outward lying position in which it extends from the feeding bowl and forms a perch, and inwardly lying position in which it overlies and closes the feeding bowl.

In an alternative embodiment of the bird feeding port assembly according to the present invention the assembly is mounted through the opening in the bird feed containment housing to define a feeding area within the housing itself. This feeding area is accessible through the opening in the housing. A closure member within the assembly is moveable between a first position in which it covers the feeding area and a second position in which it extends outwardly from the housing and the feeding area is uncovered to allow access to bird feed lying therein.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A bird feeding port assembly for mounting to a bird feed containment housing through an opening in the wall of the housing, the assembly defining a feeding area having an opening to the housing, a support frame which is adapted in use to secure the assembly to the housing such that the opening to the housing allows seed to flow into the feed area, and a closure member which is moveable between a first extended position in which the closure member extends outwardly from the outward side of the assembly leaving the feeding area open and a second retracted position in which the closure member overlies the feeding area and prevents access thereto.

2. A bird feeding port assembly as claimed in claim 1, wherein an outward edge of the closure member comprises an upwardly turned projection.

3. A bird feeding port assembly as claimed in claim 1, wherein an outward edge of the closure member comprises an upwardly turned projection, and wherein the upwardly turned projection is adapted, when the closure member is in the extended position, to serve as a perch on which birds can stand to feed from the feeding area.

4. A bird feeding port assembly as claimed in claim 1, wherein the feeding area comprises a feeding bowl.

5. A bird feeding port assembly as claimed in claim 1, wherein the feeding area comprises a feeding bowl, and wherein the feeding bowl comprises an opening in the rear thereof and the support means is adapted to secure the feeding bowl to the exterior of the housing such that the opening in the rear of the feeding bowl is aligned with the opening in the housing wall.

6. A bird feeding port assembly as claimed in claim 1, further comprising a cover or hood located above and spaced from the feeding area.

7. A bird feeding port assembly as claimed in claim 6, wherein the feeding area and the cover are formed together as a single unitary construction.

8. A bird feeding port assembly as claimed in claim 1, wherein the closure member comprises a planar member and is slidable within slots and/or grooves in the feeding bowl between the first extended position and the second retracted position.

9. A bird feeding port assembly as claimed in claim 8, wherein the closure member is retained by, and slidable within, a slot in the outward side of the feeding bowl.

10. A bird feeding port assembly as claimed in claim 8, wherein the sides of the closure member are retained by, and slidable within, a pair of grooves on opposite sides of the feeding bowl.

11. A bird feeding port assembly as claimed in claim 1, wherein the closure member comprises a stop bar on the rearward edge thereof which prevents it from being slideable out of the slots and/or grooves in the feeding bowl which retain it.

12. A bird feeding port assembly as claimed in claim 11, wherein the stop bar is arranged to abut against the inner face of the outward side of the feeding bowl.

13. A bird feeding port assembly as claimed in claim 11, wherein the closure member extends through the opening in the rear of the feeding bowl and into the housing, and the stop bar engages against the uppermost side of the opening.

14. A bird feeding port assembly as claimed in claim 1, wherein the feeding area comprises a feeding bowl, and wherein the rearward edge of the closure member is shaped so as to substantially match the shape of the feeding bowl.

15. A bird feeding port assembly as claimed in claim 1, wherein the closure member is connected to the outward side of the feeding area by a hinge and is pivotable between the first extended position and the second retracted position.

16. A bird feeding port assembly as claimed in claim 15, wherein the closure member is pivotable about the forward edge of the feeding are between an outward lying position in which it extends from the feeding area and forms a perch, and inwardly lying position in which it overlies and closes the feeding bowl.

17. A bird feeding port assembly as claimed in claim 1, wherein the assembly is mounted through the opening in the bird feed containment housing to define a feeding area within the housing itself.

18. A bird feeding port assembly as claimed in claim 17, wherein the feeding area is accessible through the opening in the housing.

19. A bird feeding port assembly as claimed in claim 17, wherein the closure member is located within the assembly and is moveable between a first position in which it covers the feeding area and a second position in which it extends outwardly from the housing and the feeding area is uncovered to allow access to bird feed lying therein.

20. A bird feeding port assembly as claimed in claim 1, wherein the support frame and/or the opening in the wall of the bird feed containment housing comprises a snap-fit projection adapted to securely mount the assembly in the opening in the wall of the housing.
